(19) United States
(12) Patent Application Publication
(10) Pub. No.: US 2026/0208506 A1
(43) Pub. Date: Jul. 23, 2026

(54) DRYING METHOD BY DRYING DEVICE, DRYING DEVICE, AND RECORDING DEVICE

(71) Applicant: SEIKO EPSON CORPORATION, Tokyo (JP)

(72) Inventor: Tadashi AIZAWA, MATSUMOTO-SHI (JP)

(21) Appl. No.: 19/453,212

(22) Filed: Jan. 20, 2026

(30) Foreign Application Priority Data
Jan. 22, 2025 (JP) 2025-008856

(51) Int. Cl. B41J 11/00

(52) U.S. Cl. CPC B41J 11/00242; B41J 11/007

(57) ABSTRACT

A drying device includes a heating section configured to heat a medium onto which liquid is ejected and a first contact section configured to come into contact with the medium between the heating section and the medium. The heating section includes a first electrode, a second electrode disposed to surround the first electrode in plan view from a first direction facing the medium, a first conductor including a coil and configured to electrically couple a transmission line capable of transmitting a high-frequency voltage and the first electrode, and a second conductor configured to electrically couple the transmission line and the second electrode. A drying method by the drying device includes a drying step of drying an image region of the medium on which an image is recorded and a preheating step of heating the first contact section before the drying step.

The present application is based on, and claims priority from JP Application Serial Number 2025-008856, filed January 22, 2025, the disclosure of which is hereby incorporated by reference herein in its entirety.

### BACKGROUND

### Technical Field

The present disclosure relates to a drying method by a drying device, a drying device, and a recording device.

### Related Art

For example, JP-A-2022-39286 discloses a liquid ejecting apparatus including a drying device that dries a medium in a state in which the medium is in contact with a support section, which is an example of a contact section. The drying device explained above includes, in order to improve the drying efficiency, an AC electric field generation section that dries the medium by generating electromagnetic waves for the medium onto which liquid has been ejected. The AC electric field generation section explained above is an example of a heating section and generates electromagnetic waves for the medium by supplying a high-frequency voltage between a first electrode and a second electrode. Accordingly, it is possible to dry the medium onto which the liquid has been ejected.

JP-A-2022-39286 is an example of the related art.

However, in the drying device explained above, although the medium is dried by heating the liquid ejected onto the medium, when the temperature of the contact section with which the medium is in contact is lower than the temperature of the medium, an amount of heat for the medium is easily transferred to the contact section. Accordingly, the drying efficiency of the medium is likely to be deteriorated.

### SUMMARY

According to an aspect of the present disclosure, there is provided a drying method by a drying device including a heating section configured to heat a medium onto which liquid is ejected and a first contact section configured to come into contact with the medium between the heating section and the medium, the heating section including: a first electrode; a second electrode disposed to surround the first electrode in plan view from a first direction facing the medium; a first conductor including a coil and configured to electrically couple a transmission line capable of transmitting a high-frequency voltage and the first electrode; and a second conductor configured to electrically couple the transmission line and the second electrode, the drying method including: a drying step of drying an image region of the medium on which an image is recorded; and a preheating step of heating the first contact section before the drying step.

According to an aspect of the present disclosure, there is provided a drying device including: a heating section configured to heat a medium onto which liquid is ejected; and a first contact section configured to come into contact with the medium between the heating section and the medium, wherein the heating section includes: a first electrode; a second electrode disposed to surround the first electrode in plan view from a first direction facing the medium; a first conductor including a coil and configured to electrically couple a transmission line capable of transmitting a high-frequency voltage and the first electrode; and a second conductor configured to electrically couple the transmission line and the second electrode, wherein the first contact section contains a material having an electromagnetic heat-generating property.

According to an aspect of the present disclosure, there is provided a recording device including: a recording section configured to record an image on a medium by ejecting liquid onto the medium; a heating section configured to heat the medium onto which the liquid is ejected by the recording section; and a first contact section configured to come into contact with the medium between the heating section and the medium, wherein the heating section includes: a first electrode; a second electrode disposed to surround the first electrode in plan view from a first direction facing the medium; a first conductor including a coil and configured to electrically couple a transmission line capable of transmitting a high-frequency voltage and the first electrode; and a second conductor configured to electrically couple the transmission line and the second electrode, wherein the first contact section contains a material having an electromagnetic heat-generating property.

### BRIEF DESCRIPTION OF THE DRAWINGS

FIG. 1 is a schematic diagram illustrating a recording system in a first embodiment.

FIG. 2 is a schematic diagram illustrating a drying unit in the first embodiment.

FIG. 3 is a perspective view illustrating a heating section in the first embodiment.

FIG. 4 is a schematic diagram illustrating the drying unit in a preheating step and a drying step in the first embodiment.

FIG. 5 is a flowchart illustrating temperature monitoring processing in the first embodiment.

FIG. 6 is a schematic diagram illustrating a drying unit in a preheating step and a drying step in a third embodiment.

FIG. 7 is a perspective view illustrating a drying unit in a fourth embodiment.

### DESCRIPTION OF EMBODIMENTS

### First Embodiment

Hereinafter, a drying method by a drying device, a drying device, and a recording system including a recording device according to an embodiment are explained. In the following explanation, a direction intersecting a vertical direction Z is represented as a width direction X and a direction intersecting the vertical direction Z and the width direction X is represented as an intersecting direction Y. One direction in the width direction X is represented as a first width direction X1 and the other direction in the width direction X is represented as a second width direction X2. One direction in the intersecting direction Y is represented as a first intersecting direction Y1 and the other direction in the intersecting direction Y is represented as a second intersecting direction Y2. An upward direction in the vertical direction Z is represented as an upward direction Z1 and a downward direction in the vertical direction Z is represented as a downward direction Z2. The upward direction Z1 is equivalent to an example of a first direction. Plan view from the upward direction Z1 is simply referred to as plan view.

### Configuration of a recording system 10

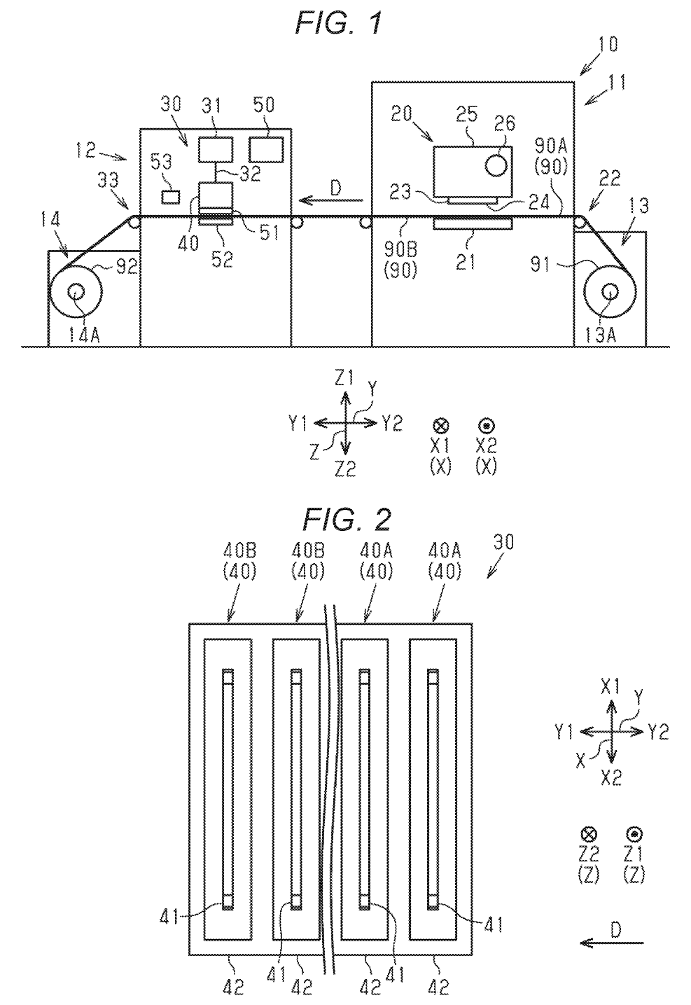

As illustrated in FIG. 1, a recording system 10 is a system that performs recording on a medium 90. In particular, the recording system 10 is a system that performs recording on the medium 90 by ejecting liquid onto the medium 90. The recording system 10 is a system that dries the medium 90 after the recording onto which the liquid has been ejected. The medium 90 is fabric but may be, for example, paper.

The recording system 10 includes a recording device 11. The recording device 11 is configured to perform recording on the medium 90. In particular, the recording device 11 performs recording on the medium 90 by ejecting liquid onto the medium 90. The recording device 11 may be an inkjet printer that performs recording by ejecting ink, which is an example of the liquid, onto the medium 90.

The liquid may be pigment ink. The pigment ink contains pigment, water, and a solvent. The solvent may contain, for example, glycerin. Glycerin is a solvent for preventing clogging in a nozzle that ejects the liquid. Vaporization of glycerin improves the wear resistance of the medium 90 onto which the pigment ink has been ejected. The pigment ink may be either colored or colorless.

The recording system 10 includes a drying device 12. The drying device 12 is configured to dry the medium 90 after the recording onto which the recording device 11 has ejected the liquid. In particular, the drying device 12 dries the medium 90 after the recording by generating electromagnetic waves.

The recording system 10 includes a feeding section 13. The feeding section 13 lets out the medium 90 before recording to the recording device 11. The feeding section 13 includes a feeding roller 13A. The feeding roller 13A extends in the width direction X. In the width direction X, the width of the feeding roller 13A is larger than the width of the medium 90. The feeding roller 13A is configured to rotatably hold a first roll body 91. The first roll body 91 is the medium 90 before recording that is rolled up. The medium 90 may be long. As explained above, the feeding roller 13A holds the medium 90 to be let out to the recording device 11.

The recording system 10 includes a winding section 14. The winding section 14 winds the medium 90 after the recording on which the recording has been performed by the recording device 11. In particular, the winding section 14 winds the medium 90 after the recording dried by the drying device 12. The winding section 14 includes a winding roller 14A. The winding roller 14A extends in the width direction X. In the width direction X, the width of the winding roller 14A is larger than the width of the medium 90. The winding roller 14A is configured to rotatably hold a second roll body 92. The second roll body 92 is the medium 90 after the recording that is rolled up. As explained above, the winding roller 14A winds the medium 90 on which the recording has been performed by the recording device 11 and that has been dried by the drying device 12.

### Configuration of the recording device 11

The recording device 11 includes a recording section 20, a recording support section 21, and a recording conveyance section 22. The recording section 20 is configured to record an image on the medium 90 by ejecting liquid onto the medium 90. A region where the recording section 20 records an image is equivalent to an example of an image region. The recording section 20 ejects the liquid onto a front surface 90A of the medium 90. The recording section 20 performs recording on the medium 90 supported by the recording support section 21. The recording section 20 performs recording on the medium 90 conveyed by the recording conveyance section 22.

The recording section 20 includes a head 23. The head 23 may be a serial head or may be a line head. The serial head is a head that performs scanning in the width direction X of the medium 90. The line head is a head that simultaneously performs recording over the width direction X of the medium 90.

The head 23 includes a nozzle surface 24 in which a not-illustrated plurality of nozzles are opened. The nozzle surface 24 is a surface facing the downward direction Z2. The nozzle surface 24 is a surface facing the front surface 90A of the medium 90 conveyed by the recording conveyance section 22. Each of the plurality of nozzles is configured to open in the downward direction Z2. Each of the plurality of nozzles is configured to eject liquid.

The recording section 20 may include a carriage 25 and a carriage support section 26. The carriage 25 is configured to support the head 23. The carriage support section 26 extends in the width direction X. The carriage support section 26 supports the carriage 25 to be movable along the width direction X. The carriage 25 is movable in the width direction X along the carriage support section 26 with a driving force from a not-illustrated driving source.

The recording support section 21 is configured to support the medium 90 conveyed by the recording conveyance section 22. The recording support section 21 is located in the downward direction Z2 of the recording section 20. The recording support section 21 supports a rear surface 90B of the medium 90 conveyed by the recording conveyance section 22. The recording support section 21 is located in the downward direction Z2 of the head 23.

The recording conveyance section 22 is configured to convey the medium 90 in a conveyance direction D. The conveyance direction D is a direction in the intersecting direction Y. The recording conveyance section 22 may include a plurality of rollers. The recording conveyance section 22 conveys the medium 90 in the conveyance direction D using the plurality of rollers but may convey the medium 90 in the conveyance direction D using a conveyor belt driven by the plurality of rollers. The recording conveyance section 22 may perform intermittent conveyance in which conveyance and stop of the medium 90 are repeated.

### Configuration of the drying device 12

The drying device 12 includes a drying unit 30. The drying unit 30 is configured to dry the medium 90 after recording. That is, the drying device 12 sets, as a target object to be dried, the medium 90 on which recording has been performed by the recording section 20.

The drying unit 30 is configured to dry the medium 90 after the recording by generating electromagnetic waves. The drying unit 30 is located in the upward direction Z1 and the downward direction Z2 of the medium 90 but may be located in the upward direction Z1 of the medium 90 or may be located in the downward direction Z2 of the medium 90.

The drying device 12 includes a high-frequency voltage generation section 31. The drying device 12 may include a plurality of high-frequency voltage generation sections 31. The high-frequency voltage generation section 31 is configured to generate a high-frequency voltage. The high-frequency voltage generation section 31 supplies the high-frequency voltage to the drying unit 30 via a transmission line 32.

The transmission line 32 is a line that connects the drying unit 30 and the high-frequency voltage generation section 31. The transmission line 32 is capable of transmitting, to the drying unit 30, the high-frequency voltage supplied from the high-frequency voltage generation section 31. That is, the transmission line 32 is capable of transmitting a high-frequency voltage.

The transmission line 32 may be a coaxial cable but is not limited to the coaxial cable. The transmission line 32 may include a first line and a second line. The first line may be a core wire of the transmission line 32. The second line may be an electromagnetic shield that covers the first line.

The drying device 12 includes a drying conveyance section 33. The drying conveyance section 33 is configured to convey the medium 90 in the conveyance direction D. The drying conveyance section 33 is an example of a conveyance section. The conveyance direction D is a direction in the intersecting direction Y. The drying conveyance section 33 may convey the medium 90 in the conveyance direction D using a plurality of rollers. The drying conveyance section 33 may perform continuous conveyance for continuously conveying the medium 90. Slack of the medium 90 may occur between the recording conveyance section 22 and the drying conveyance section 33.

The drying device 12 includes a control section 50. The control section 50 controls the drying device 12. Specifically, the control section 50 controls the drying unit 30. The control section 50 controls the high-frequency voltage generation section 31. The control section 50 controls the drying conveyance section 33.

The control section 50 may include one or more processors that execute various kinds of processing according to a computer program. The control section 50 may include one or more dedicated hardware circuits. The control section 50 may include an application specific integrated circuit that executes at least some of the various kinds of processing. The control section 50 may include a circuit including a combination of a processor and a hardware circuit. The processor includes a CPU and memories such as RAM and ROM. The memories store program codes or commands configured to cause the CPU to execute processing. The memories, that is, computer readable media include all readable media that can be accessed by a general-purpose or dedicated computer.

The drying unit 30 includes a heating section 40. The heating section 40 heats the medium 90 onto which liquid has been ejected by the recording section 20. The heating section 40 is configured to generate electromagnetic waves according to application of a high-frequency voltage. The heating section 40 is an example of an electromagnetic wave generation section. The heating section 40 is located in the upward direction Z1 of the medium 90 but is not limited thereto.

The heating section 40 heats the medium 90 from the front surface 90A , thereby drying the medium 90. Specifically, the heating section 40 heats, from the front surface 90A, the liquid ejected onto the medium 90. The heating section 40 dries the medium 90 by vaporizing the liquid ejected onto the medium 90. That is, the heating section 40 is a type of drying the medium 90 regardless of whether water vapor is saturated around the medium 90. For this reason, the heating section 40 does not need to blow dry gas in which water vapor is not saturated around the medium 90.

The heating section 40 generates an AC electric field by generating the electromagnetic waves. The electromagnetic waves generated by the heating section 40 have an electric field as a main component. The heating section 40 can significantly reduce induction of a magnetic field by a generated electric field as compared with a heating section that generates normal electromagnetic waves.

As a specific example, the heating section 40 generates electromagnetic waves of 2.4 GHz but is not limited thereto. The heating section 40 may generate electromagnetic waves of, for example, 3 MHz to 300 MHz. The heating section 40 may generate, for example, electromagnetic waves of 300 MHz to 30 GHz and may generate, above all, electromagnetic waves of 10 MHz to 20 GHz.

The drying unit 30 includes a first contact section 51 and a second contact section 52. That is, the drying device 12 includes the first contact section 51 and the second contact section 52. The first contact section 51 is disposed to face the front surface 90A of the medium 90. The first contact section 51 is provided between the heating section 40 and the medium 90. The first contact section 51 may have a flat plate shape. The first contact section 51 is capable of coming into contact with the medium 90 between the heating section 40 and the medium 90. The first contact section 51 protects a first electrode 41 and a second electrode 42 explained below.

The second contact section 52 is disposed to face the rear surface 90B of the medium 90. The second contact section 52 may have a flat plate shape. The second contact section 52 is capable of coming into contact with the medium 90. The second contact section 52 is capable of supporting the medium 90. The second contact section 52 is configured to sandwich the medium 90 between the second contact section 52 and the first contact section 51. As explained above, the first contact section 51 and the second contact section 52 are provided to sandwich the medium 90.

The first contact section 51 and the second contact section 52 are made of a material that transmits electromagnetic waves generated by the heating section 40. The first contact section 51 and the second contact section 52 are made of a member having insulation. The first contact section 51 and the second contact section 52 may be glass plates. The first contact section 51 and the second contact section 52 may be ceramic having high transmittance. The first contact section 51 and the second contact section 52 may be made of resin having a low dielectric loss tangent. The first contact section 51 and the second contact section 52 may be made of polypropylene. The first contact section 51 and the second contact section 52 may be made of polyethylene.

The drying unit 30 includes a temperature detection section 53. The temperature detection section 53 is configured to detect at least the temperature of the first contact section 51. The temperature detection section 53 may detect the temperatures of the first contact section 51 and the second contact section 52.

### Disposition of a plurality of heating sections 40

As illustrated in FIG. 2, the drying unit 30 may include a plurality of heating sections 40. The plurality of heating sections 40 are disposed side by side in the intersecting direction Y. The plurality of heating sections 40 may be integrally configured to share the second electrode 42 explained below. The second electrode 42 in the plurality of heating sections 40 may be shared at positions adjacent to one another in the intersecting direction Y.

The plurality of heating sections 40 may include an upstream heating section 40A and a downstream heating section 40B. The plurality of heating sections 40 may include a plurality of upstream heating sections 40A and a plurality of downstream heating sections 40B. The number of upstream heating sections 40A is larger than the number of downstream heating sections 40B but may be smaller than the number of downstream heating sections 40B or may be the same as the number of downstream heating sections 40B.

The upstream heating section 40A and the downstream heating section 40B may be controlled by the control section 50 to have different heating values. When the medium 90 is dried, the upstream heating section 40A may be controlled to have a higher heating value than the downstream heating section 40B.

The upstream heating section 40A and the downstream heating section 40B may be respectively coupled to different pluralities of high-frequency voltage generation sections 31. The control section 50 may control the heating value from the upstream heating section 40A and the heating value from the downstream heating section 40B to be different by differentiating high-frequency voltages respectively output from the pluralities of high-frequency voltage generation sections 31 to the upstream heating section 40A and the downstream heating section 40B.

As a specific example, a case in which the medium 90 onto which pigment ink has been ejected as the liquid is dried is explained. When the medium 90 onto which the pigment ink has been ejected is dried, temporary drying and main drying are performed. In the temporary drying, water contained in the pigment ink is vaporized at approximately 100°C. In the case explained above, it is desirable to rapidly raise the temperature of the pigment ink.

The main drying is performed after the temporary drying. In the main drying, a solvent contained in the pigment ink is vaporized at approximately 270°C to 300°C. In the main drying, it is desirable to maintain the temperature of the pigment ink without excessively raising the temperature in order to increase the certainty of vaporization of glycerin without causing thermal denaturation on the medium 90. The main drying is preferably performed for a longer time than the temporary drying.

For this reason, the upstream heating section 40A is located upstream in the conveyance direction D to perform the temporary drying. The downstream heating section 40B is located downstream in the conveyance direction D to perform the main drying. The upstream heating section 40A generates electromagnetic waves stronger than electromagnetic waves generated by the downstream heating section 40B. In the temporary drying, the upstream heating section 40A can generate electromagnetic waves stronger than electromagnetic waves generated by the downstream heating section 40B and rapidly raise the temperature. Thereafter, in the main drying, the downstream heating section 40B can maintain the temperature without excessively raising the temperature.

### Configuration of the heating section 40

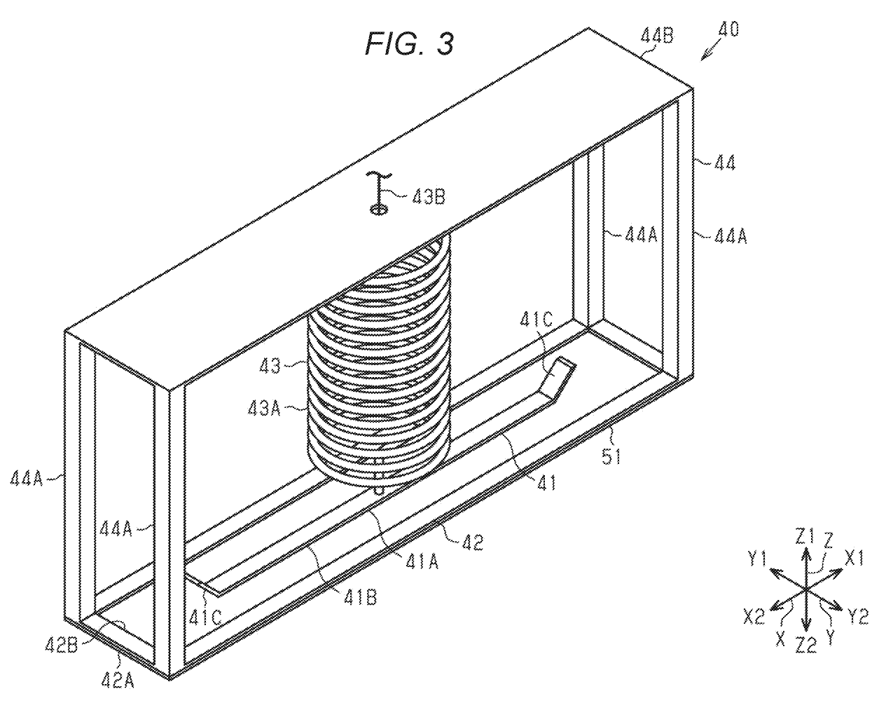

Here, a configuration of the heating section 40 is explained in detail with reference to FIG. 3. Hereinafter, one heating section 40 is representatively explained.

As illustrated in FIG. 3, the heating section 40 includes a first electrode 41, a second electrode 42, a first conductor 43, and a second conductor 44. FIG. 3 is a diagram in which the first electrode 41 and the second electrode 42 are disposed on the upward direction Z1 side of the medium 90.

The first electrode 41 has a flat plate shape but may have a bar shape. The first electrode 41 is longitudinal in the width direction X in plan view. That is, the first electrode 41 extends in the width direction X in plan view. The first electrode 41 may have a rectangular shape in plan view.

The first electrode 41 includes a first electrode surface 41A. The first electrode surface 41A is a surface facing the downward direction Z2. That is, the first electrode surface 41A is a surface facing the front surface 90A of the medium 90. The first electrode 41 may be disposed such that the first electrode surface 41A is in contact with the first contact section 51.

The first electrode 41 includes a central portion 41B and both end portions 41C. The central portion 41B is a part located at the center in the width direction X. Both the end portions 41C are parts located at both ends in the width direction X. The central portion 41B and both the end portions 41C are integrally provided.

The central portion 41B configures the first electrode surface 41A. The central portion 41B is provided at a position overlapping the second electrode 42 in the vertical direction Z. That is, at least a part of the first electrode 41 is provided at the position overlapping the second electrode 42 in the vertical direction Z.

Both the end portions 41C are configured to be inclined upward with respect to the outer side in the width direction X. Both the end portions 41C are located to separate from the first contact section 51. That is, both the end portions 41C are extended in the upward direction Z1 separating from the medium 90 in the vertical direction Z. Both the end portions 41C may be curved to separate from the first contact section 51.

The second electrode 42 has a flat plate shape. The second electrode 42 includes a second electrode surface 42A. The second electrode surface 42A is a surface facing the downward direction Z2. That is, the second electrode surface 42A is a surface facing the front surface 90A of the medium 90. The second electrode 42 may be disposed such that the second electrode surface 42A is in contact with the first contact section 51.

The second electrode 42 includes an opening section 42B. The opening section 42B has a rectangular shape in plan view but may have a rounded rectangular shape. The first electrode 41 is located in the opening section 42B in plan view. The opening section 42B surrounds the first electrode 41 in plan view. That is, the second electrode 42 is disposed to surround the first electrode 41 in plan view.

The first conductor 43 is configured to electrically couple the transmission line 32 and the first electrode 41. The first conductor 43 includes a coil 43A. The coil 43A extends in the vertical direction Z. One end of the coil 43A is coupled to the first electrode 41. The other end of the coil 43A is coupled to a conductive wire 43B. The conductive wire 43B is coupled to the transmission line 32.

The second conductor 44 is configured to electrically couple the transmission line 32 and the second electrode 42. The second conductor 44 may include a pillar 44A. The second conductor 44 may include a plurality of pillars 44A. The pillar 44A is electrically coupled to the second electrode 42. The pillar 44A extends in the upward direction Z1 from the second electrode 42. The pillar 44A is made of metal.

The second conductor 44 may include a top plate 44B. The top plate 44B is electrically coupled to the pillar 44A. The top plate 44B is provided at the upper end portion of the pillar 44A. The top plate 44B may be integrated with the pillar 44A. The top plate 44B is made of metal.

Since the heating section 40 is configured as explained above, when a high-frequency voltage is applied, the first electrode 41 and the second electrode 42 generate electromagnetic waves according to the application of the high-frequency voltage to thereby heat the medium 90.

The heating section 40 explained above can transmit large thermal energy to the medium 90 by generating the electromagnetic waves. The heating section 40 may be an electromagnetic wave type rather than a heat conduction type and may not include a member such as a heating wire for heating. Accordingly, it is possible to achieve a reduction in the size of the heating section 40.

A minimum separation distance between the first electrode 41 and the second electrode 42 is 1/10 or less of the wavelength of electromagnetic waves output from the heating section 40. Accordingly, the electromagnetic waves generated when the high-frequency voltage is applied can be attenuated in the vicinity of the first electrode 41 and the second electrode 42. Accordingly, the intensity of the electromagnetic waves reaching the distance from the first electrode 41 and the second electrode 42 can be reduced. That is, the electromagnetic waves generated from the heating section 40 are very strong in the vicinity of the first electrode 41 and the second electrode 42 and are very weak at the distance.

Since a frequency band of electromagnetic waves to be generated is appropriately controlled, the heating section 40 explained above can intensively generate an AC electric field in the vicinity of the first electrode 41 and the second electrode 42. In other words, it is possible to suppress the influence on the surroundings involved in the generation of the electromagnetic waves beyond the vicinity of the first electrode 41 and the second electrode 42. For example, a range of 3 mm to 3 cm may be equivalent to the vicinity of the first electrode 41 and the second electrode 42.

### Drying method for the medium 90

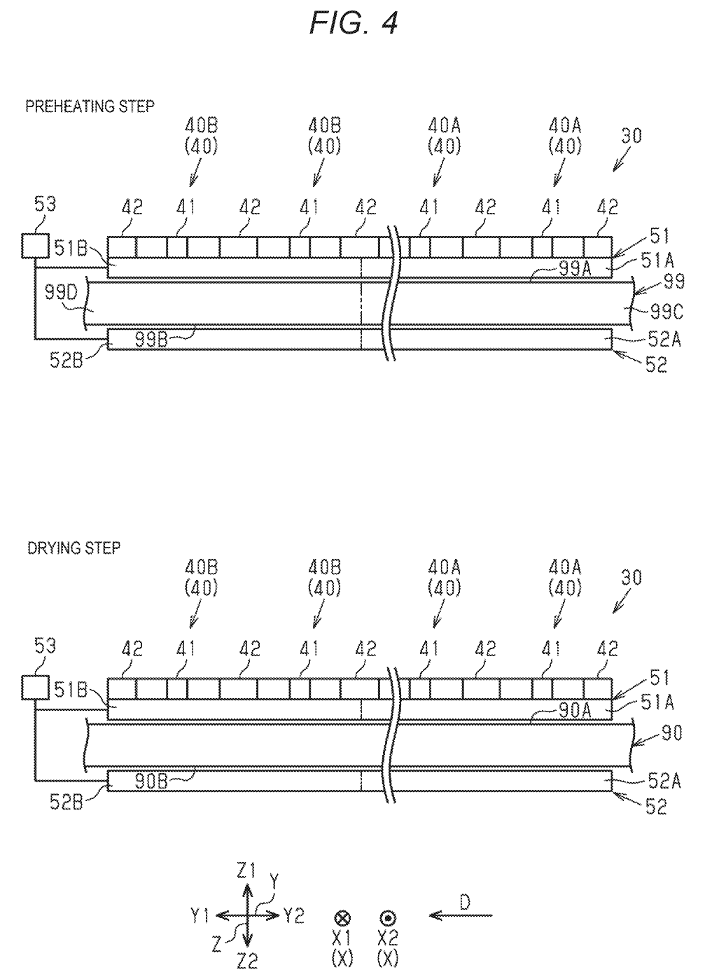

Next, a drying method for the medium 90 by the drying device 12 is explained with reference to FIG. 4.

As illustrated in FIG. 4, a drying step is performed after a preheating step is performed. That is, the preheating step is performed before the drying step. The preheating step is a step of heating the first contact section 51 and the second contact section 52 before the drying step.

In the preheating step, a medium for preheating 99 is conveyed between the first contact section 51 and the second contact section 52. The medium for preheating 99 is configured separately from the medium 90 to be dried but may be continuously connected to the medium 90 to be dried.

Liquid is applied to the medium for preheating 99. In the medium for preheating 99, the liquid is applied to the front surface 99A. However, the liquid may be applied to the rear surface 99B or the liquid may be applied to both of the front surface 99A and the rear surface 99B. In the medium for preheating 99, the liquid is applied to the front surface 99A in a predetermined pattern. As explained above, the medium for preheating 99 includes a preheating region to which the liquid is applied.

The medium for preheating 99 includes an upstream region 99C and a downstream region 99D. The upstream region 99C is a region located upstream in the conveyance direction D. The upstream region 99C is disposed to be sandwiched between a first upstream region 51A of the first contact section 51 and a second upstream region 52A of the second contact section 52.

The downstream region 99D is a region located downstream in the conveyance direction D. The downstream region 99D is located further downstream in the conveyance direction D than the upstream region 99C. The downstream region 99D is disposed to be sandwiched between a first downstream region 51B of the first contact section 51 and a second downstream region 52B of the second contact section 52.

More liquid is applied to the downstream region 99D than to the upstream region 99C. The liquid may be applied to the downstream region 99D in a solid pattern. The liquid may be applied to the upstream region 99C at predetermined intervals unlike the solid pattern or may be applied to the upstream region 99C in a solid pattern of a smaller amount of the liquid than in the downstream region 99D.

The first upstream region 51A is a region located upstream in the conveyance direction D of the first contact section 51. The first downstream region 51B is a region located downstream in the conveyance direction D of the first contact section 51. The first upstream region 51A is a region facing the upstream heating section 40A. The first downstream region 51B is a region facing the downstream heating section 40B.

The second upstream region 52A is a region located upstream in the conveyance direction D in the second contact section 52. The second downstream region 52B is a region located downstream in the conveyance direction D in the second contact section 52. The second upstream region 52A is a region facing the upstream heating section 40A. The second downstream region 52B is a region facing the downstream heating section 40B.

In the preheating step, the heating section 40 heats the liquid of the medium for preheating 99 according to the application of the high-frequency voltage. Accordingly, when the liquid applied to the medium for preheating 99 is vaporized, the medium for preheating 99, the first contact section 51, and the second contact section 52 are heated.

As explained above, in the preheating step, the heating section 40 heats the first contact section 51 and the second contact section 52 in a state in which the first contact section 51 and the second contact section 52 are brought into contact with the medium for preheating 99 to which the liquid has been applied.

In particular, more liquid is applied to the downstream region 99D than to the upstream region 99C. For this reason, an amount of heat transferred to the first downstream region 51B and the second downstream region 52B facing the downstream region 99D is higher than an amount of heat transferred to the first upstream region 51A and the second upstream region 52A facing the upstream region 99C.

As explained above, in the preheating step, the heating section 40 heats the first contact section 51 such that the first downstream region 51B has a higher temperature than the first upstream region 51A. The heating section 40 heats the second contact section 52 such that the second downstream region 52B has a higher temperature than the second upstream region 52A.

In the preheating step, the downstream heating section 40B may be controlled to have a higher heating value than the upstream heating section 40A. Accordingly, it is possible to reduce the difference between a time in which the liquid applied to the upstream region 99C vaporizes and a time in which the liquid applied to the downstream region 99D vaporizes.

When the preheating processing ends, the medium for preheating 99 is discharged from between the first contact section 51 and the second contact section 52. An end condition for the preheating processing may be satisfied when a predetermined time elapses after the heating of the medium for preheating 99 is started. The end condition for the preheating processing may be satisfied when it is determined based on a detection signal from the temperature detection section 53 that the first contact section 51 and the second contact section 52 have reached a predetermined temperature.

The drying step is a step of, after the preheating step, drying an image region of the medium 90 on which an image is recorded. In the drying step, the medium 90 to be dried is conveyed between the first contact section 51 and the second contact section 52.

In the drying step, by the liquid ejected onto the medium 90 vaporizing according to the application of the high-frequency voltage, the heating section 40 dries the medium 90. In this case, the first contact section 51 and the second contact section 52 are in a state in which the temperature has risen in the preheating step. For this reason, an amount of heat to the liquid ejected onto the medium 90 is less likely to be transferred to the first contact section 51 and the second contact section 52.

In particular, in the drying step, the upstream heating section 40A may be controlled to have a higher heating value than the downstream heating section 40B. Accordingly, it is possible to perform the temporary drying and the main drying at an appropriate temperature by conveying the medium 90 in the conveyance direction D.

### Temperature monitoring processing

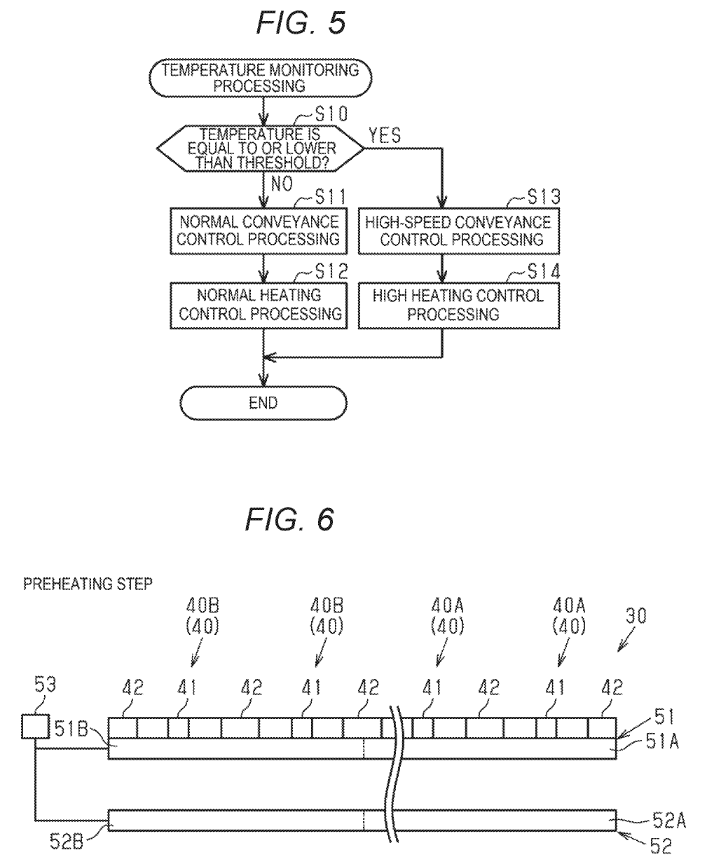

Next, temperature monitoring processing is explained with reference to FIG. 5. The temperature monitoring processing is processing executed by the control section 50 in the drying step.

As illustrated in FIG. 5, in step S10, the control section 50 determines, based on a detection signal from the temperature detection section 53, whether the temperatures of the first contact section 51 and the second contact section 52 are equal to or lower than a threshold. The threshold is a value of a degree at which an amount of heat transferred from the medium 90 to the first contact section 51 and the second contact section 52 increases.

When determining that the temperatures of the first contact section 51 and the second contact section 52 are not equal to or lower than the threshold, the control section 50 shifts the processing to step S11. When determining that the temperatures of the first contact section 51 and the second contact section 52 are equal to or lower than the threshold, the control section 50 shifts the processing to step S13.

In step S11, the control section 50 executes normal conveyance control processing. In this processing, the control section 50 reads first conveyance speed from the memory. The control section 50 controls the drying conveyance section 33 to convey the medium 90 at the first conveyance speed. The first conveyance speed is the speed at which the medium 90 is conveyed at a normal time.

In step S12, the control section 50 executes normal heating control processing. In this processing, the control section 50 reads a first high-frequency voltage from the memory. The control section 50 controls the high-frequency voltage generation section 31 to apply the first high-frequency voltage to the heating section 40. The first high-frequency voltage is a high-frequency voltage applied to the heating section 40 at the normal time.

In step S13, the control section 50 executes high-speed conveyance control processing. In this processing, the control section 50 reads second conveyance speed from the memory. The second conveyance speed is the speed at which the medium 90 is conveyed when the temperatures of the first contact section 51 and the second contact section 52 drop. The second conveyance speed is higher than the first conveyance speed. The control section 50 controls the drying conveyance section 33 to convey the medium 90 at the second conveyance speed.

In step S14, the control section 50 executes high heating control processing. In this processing, the control section 50 reads a second high-frequency voltage from the memory. The second high-frequency voltage is a high-frequency voltage applied to the heating section 40 when the temperatures of the first contact section 51 and the second contact section 52 drop. The second high-frequency voltage is higher than the first high-frequency voltage. The control section 50 controls the high-frequency voltage generation section 31 to apply the second high-frequency voltage to the heating section 40.

As explained above, in the drying step, when the temperatures of the first contact section 51 and the second contact section 52 are equal to or lower than the threshold, the control section 50 increases the heating value by the heating section 40 and increases the conveyance speed of the medium 90 by the drying conveyance section 33. In other words, the heating section 40 increases the heating value when the temperatures of the first contact section 51 and the second contact section 52 are equal to or lower than the threshold. The drying conveyance section 33 increases the conveyance speed of the medium 90 when the temperatures of the first contact section 51 and the second contact section 52 are equal to or lower than the threshold.

### Action and effects of the first embodiment

Action and effects of the first embodiment are explained.

(1-1) The drying method by the drying device 12 includes the drying step of drying an image region of the medium 90 on which an image is recorded and the preheating step of heating the first contact section 51 before the drying step. With this configuration, even when the temperature of the first contact section 51 is low, since the preheating step of heating the first contact section 51 is performed before the drying step, the temperature of the first contact section 51 can be raised in advance. For example, when the drying step is started, the temperature of the first contact section 51 has not risen, but the temperature of the first contact section 51 can be raised in advance by performing the preheating step. Accordingly, it is possible to reduce the difference between the temperature of the first contact section 51 and the temperature of the medium 90. For this reason, in the drying step, it is possible to make it difficult to transfer the amount of heat for the medium 90 to the first contact section 51. Therefore, it is possible to improve the drying efficiency of the medium 90.

(1-2) The preheating step may include a step of heating the first contact section 51 with the heating section 40 in a state in which the first contact section 51 is brought into contact with the medium for preheating 99. With this configuration, by heating the liquid applied to the medium for preheating 99, the temperature of the first contact section 51 that comes into contact with the medium for preheating 99 can be raised in advance. Accordingly, in the drying step, it is possible to make it difficult to transfer the amount of heat for the medium 90 to the first contact section 51. Therefore, it is possible to improve the drying efficiency of the medium 90.

(1-3) The liquid is pigment ink containing pigment, water, and a solvent. The preheating step is a step of heating the first contact section 51 with the heating section 40 such that the first downstream region 51B has a higher temperature than the first upstream region 51A. With this configuration, the water contained in the pigment ink can be vaporized by heating the water in the first upstream region 51A and the solvent contained in the pigment ink can be vaporized by heating the solvent in the first downstream region 51B having a higher temperature than the first upstream region 51A. Therefore, it is possible to improve the drying efficiency of the medium 90.

(1-4) In the drying step, when the medium 90 onto which a large amount of liquid is ejected is dried, the large amount of liquid vaporizes from the medium 90. For this reason, the temperature of the first contact section 51 is less likely to drop. On the other hand, in the drying step, when the medium 90 onto which a large amount of liquid is not ejected is dried, an amount of liquid vaporized from the medium 90 is small. For this reason, the temperature of the first contact section 51 easily drops. As explained above, in the related art, even after the drying step has started, in a region where the liquid is not ejected to the medium 90 and a region where an ejection amount of the liquid to the medium 90 is small, an amount of the liquid vaporizing from the medium 90 is small, and the temperature of the first contact section 51 is likely to drop.

Therefore, in the present embodiment, the drying step is a step of increasing the heating value by the heating section 40 and increasing the conveyance speed of the medium 90 when the temperature of the first contact section 51 is equal to or lower than the threshold. With this configuration, even when the temperature of the first contact section 51 is equal to or lower than the threshold in the drying step, it is possible to improve the drying efficiency of the medium 90 by increasing the heating value by the heating section 40. In addition, it is possible to reduce damage to the medium 90 by increasing the conveyance speed of the medium 90.

(1-5) The drying device 12 includes the second contact section 52 that sandwiches the medium 90 between the second contact section 52 and the first contact section 51. With this configuration, when the solvent contained in the pigment ink is vaporized, moisture at the time when the water contained in the pigment ink is vaporized stays in the vicinity of the medium 90. Accordingly, it is possible to reduce a difference in a calorific value of the pigment ink due to a type of the medium 90 and a type of the liquid. In addition, since it is possible to improve the airtightness between the first contact section 51 and the second contact section 52 and the medium 90, it is possible to dry the medium 90 in an environment in which the pigment ink is less likely to oxidize. It is possible to suppress an imbalance in the distance between the medium 90 and the heating section 40. It is possible to suppress shrinkage of the medium 90 involved in heating the medium 90. For this reason, it is possible to suppress occurrence of thermal denaturation on the medium 90. Therefore, it is possible to dry the medium 90 while maintaining the quality of the medium 90.

(1-6) The preheating step is a step of heating the first contact section 51 and the second contact section 52 before the drying step. With this configuration, even when the temperature of the second contact section 52 is low, since the preheating step of heating the second contact section 52 is performed before the drying step, the temperature of the second contact section 52 can be raised in advance. Accordingly, it is possible to reduce the difference between the temperature of the second contact section 52 and the temperature of the medium 90. Therefore, in the drying step, it is possible to make it difficult to transfer the amount of heat for the medium 90 to the second contact section 52. Therefore, it is possible to improve the drying efficiency of the medium 90.

(1-7) The preheating step may include a step of heating the second contact section 52 with the heating section 40 in a state in which the second contact section 52 is brought into contact with the medium for preheating 99. With this configuration, by heating the liquid applied to the medium for preheating 99, the temperature of the second contact section 52 that comes into contact with the medium for preheating 99 can be raised in advance. Accordingly, in the drying step, it is possible to make it difficult to transfer the amount of heat for the medium 90 to the second contact section 52. Therefore, it is possible to improve the drying efficiency of the medium 90.

(1-8) The preheating step is a step of heating the second contact section 52 with the heating section 40 such that the second downstream region 52B has a higher temperature than the second upstream region 52A. With this configuration, the water contained in the pigment ink can be vaporized by heating the water in the second upstream region 52A and the solvent contained in the pigment ink can be vaporized by heating the solvent in the second downstream region 52B having a higher temperature than the second upstream region 52A. Therefore, it is possible to improve the drying efficiency of the medium 90.

(1-9) The drying step is a step of increasing the heating value by the heating section 40 and increasing the conveyance speed of the medium 90 when the temperature of the second contact section 52 is equal to or lower than the threshold. With this configuration, even when the temperature of the second contact section 52 is equal to or lower than the threshold in the drying step, it is possible to improve the drying efficiency of the medium 90 by increasing the heating value by the heating section 40. In addition, it is possible to reduce damage to the medium 90 by increasing the conveyance speed of the medium 90.

### Second Embodiment

Next, a second embodiment is explained. In the following explanation, redundant explanation is omitted or simplified for the same components as the components in the embodiment explained above, and components different from the components in the embodiment explained above are explained.

As illustrated in FIG. 4, in the second embodiment, in the preheating step, an electromagnetic heat-generating sheet material may be adopted as the medium for preheating 99. The electromagnetic heat-generating sheet material is a sheet material having an electromagnetic heat-generating property. The electromagnetic heat-generating sheet material may be a material such as a rubber material. The medium for preheating 99 may not be applied with liquid.

As explained above, in the preheating step, the first contact section 51 and the second contact section 52 are heated by the heating section 40 in a state of being in contact with the electromagnetic heat-generating sheet material serving as the medium for preheating 99.

In particular, like the medium for preheating 99, the electromagnetic heat-generating sheet material contains a larger amount of the material having the electromagnetic heat-generating property in the downstream region 99D than in the upstream region 99C. As explained above, in the preheating step, the first contact section 51 is heated by the heating section 40 such that the first downstream region 51B has a higher temperature than the first upstream region 51A. In the preheating step, the second contact section 52 is heated by the heating section 40 such that the second downstream region 52B has a higher temperature than the second upstream region 52A.

### Action and effects of the second embodiment

Action and effects of the second embodiment are explained.

(2-1) The preheating step is a step of heating the first contact section 51 with the heating section 40 in a state in which the first contact section 51 is brought into contact with the medium for preheating 99 having the electromagnetic heat-generating property. With this configuration, by heating the medium for preheating 99 having the electromagnetic heat-generating property, the temperature of the first contact section 51 that comes into contact with the medium for preheating 99 can be raised in advance. Accordingly, in the drying step, it is possible to make it difficult to transfer the amount of heat for the medium 90 to the first contact section 51. Therefore, it is possible to improve the drying efficiency of the medium 90.

(2-2) The preheating step is a step of heating the second contact section 52 with the heating section 40 in a state in which the second contact section 52 is brought into contact with the medium for preheating 99 having the electromagnetic heat-generating property. With this configuration, by heating the medium for preheating 99 having the electromagnetic heat-generating property, the temperature of the second contact section 52 that comes into contact with the medium for preheating 99 can be raised in advance. Accordingly, in the drying step, it is possible to make it difficult to transfer the amount of heat for the medium 90 to the second contact section 52. Therefore, it is possible to improve the drying efficiency of the medium 90.

### Third Embodiment

Next, a third embodiment is explained.

As illustrated in FIG. 6, in the third embodiment, the first contact section 51 and the second contact section 52 may contain a material having an electromagnetic heat-generating property. Accordingly, in the preheating step, the first contact section 51 and the second contact section 52 are heated by the heating section 40. In the case explained above, the preheating step may be performed without using the medium for preheating 99.

The material having the electromagnetic heat-generating property may be, for example, carbon. The first contact section 51 and the second contact section 52 may be made of a material such as graphite or ceramic instead of a glass plate.

In particular, the first contact section 51 may be configured such that the first downstream region 51B contains a larger amount of the material having the electromagnetic heat-generating property than the first upstream region 51A. The second contact section 52 may be configured such that the second downstream region 52B contains a larger amount of the material having the electromagnetic heat-generating property than the second upstream region 52A.

As explained above, in the preheating step, the heating section 40 heats the first contact section 51 such that the first downstream region 51B has a higher temperature than the first upstream region 51A. The heating section 40 heats the second contact section 52 such that the second downstream region 52B has a higher temperature than the second upstream region 52A.

### Action and effects of the third embodiment

Action and effects of the third embodiment are explained.

(3-1) The first contact section 51 contains a material having an electromagnetic heat-generating property. With this configuration, since the first contact section 51 contains the material having the electromagnetic heat-generating property, the temperature of the first contact section 51 can be raised in advance. Accordingly, in the drying step, it is possible to make it difficult to transfer the amount of heat for the medium 90 to the first contact section 51. Therefore, it is possible to improve the drying efficiency of the medium 90.

(3-2) The first contact section 51 is configured such that the first downstream region 51B contains a larger amount of the material having the electromagnetic heat-generating property than the first upstream region 51A. According to this configuration, the first contact section 51 is heated by the heating section 40 such that the first downstream region 51B has a higher temperature than the first upstream region 51A. Therefore, the water contained in the pigment ink can be vaporized by heating the water in the first upstream region 51A, and the solvent contained in the pigment ink can be vaporized by heating the solvent in the first downstream region 51B having a higher temperature than the first upstream region 51A. Therefore, it is possible to improve the drying efficiency of the medium 90.

(3-3) The second contact section 52 contains a material having an electromagnetic heat-generating property. According to this configuration, since the second contact section 52 containing the material having the electromagnetic heat-generating property is heated, the temperature of the second contact section 52 can be raised in advance. Accordingly, in the drying step, it is possible to make it difficult to transfer the amount of heat for the medium 90 to the second contact section 52. Therefore, it is possible to improve the drying efficiency of the medium 90.

(3-4) The second contact section 52 is configured such that the second downstream region 52B contains a larger amount of the material having the electromagnetic heat-generating property than the second upstream region 52A. With this configuration, the second contact section 52 is heated by the heating section 40 such that the second downstream region 52B has a higher temperature than the second upstream region 52A. For this reason, the water contained in the pigment ink can be vaporized by heating the water in the second upstream region 52A and the solvent contained in the pigment ink can be vaporized by heating the solvent in the second downstream region 52B having a higher temperature than the second upstream region 52A. Therefore, it is possible to improve the drying efficiency of the medium 90.

### Fourth Embodiment

Next, a fourth embodiment is explained.

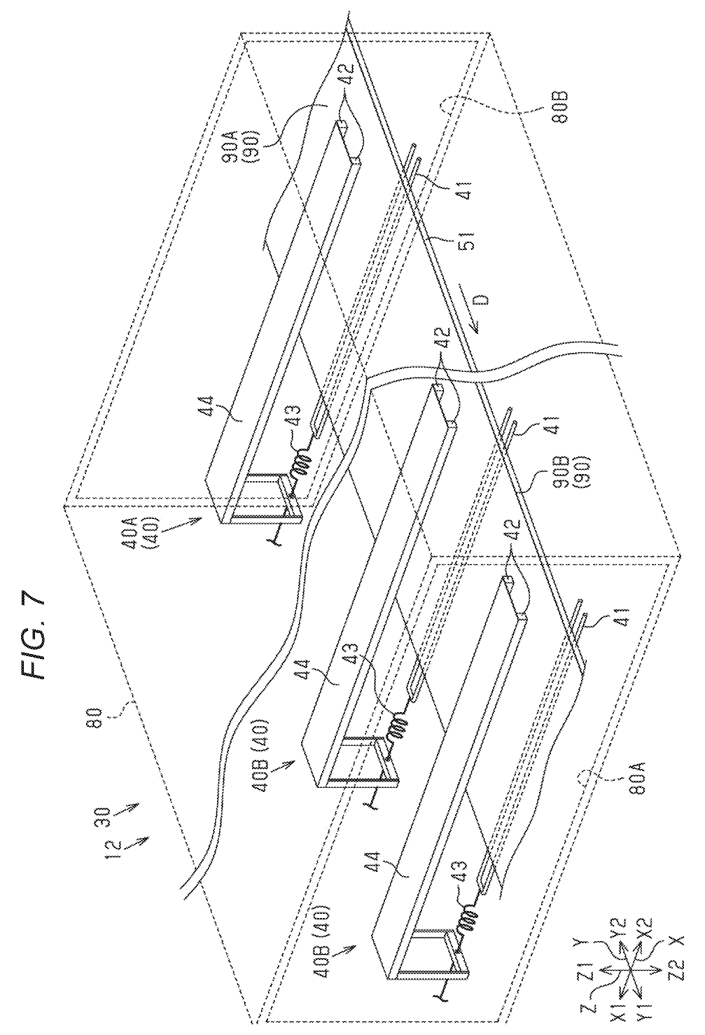

As illustrated in FIG. 7, in the fourth embodiment, the drying unit 30 may include a conductor housing 80. In FIG. 7, the conductor housing 80 is indicated by a broken line.

The conductor housing 80 may be provided on the inside of a housing of the drying device 12. The conductor housing 80 has conductivity. The conductor housing 80 is configured to house the heating section 40. The conductor housing 80 may be configured to house a plurality of heating sections 40. The conductor housing 80 has a tubular shape conforming to a conveyance path of the medium 90. The conductor housing 80 may be provided such that the conveyance direction D is longitudinal.

The conductor housing 80 includes a discharge port 80A. The discharge port 80A is provided in the first intersecting direction Y1 of the conductor housing 80. The discharge port 80A is provided in order to discharge the medium 90 from the inside to the outside of the conductor housing 80. The conductor housing 80 includes a carry-in port 80B. The carry-in port 80B is provided in the second intersecting direction Y2 of the conductor housing 80. The carry-in port 80B is provided in order to convey the medium 90 from the outside to the inside of the conductor housing 80.

The conductor housing 80 may be electrically coupled to the second electrode 42. The conductor housing 80 may be grounded. Accordingly, the conductor housing 80 functions in the same manner as the second electrode 42. As explained above, the heating section 40 may generate electromagnetic waves with the first electrode 41, the second electrode 42, and the conductor housing 80.

### Modifications

The present embodiment can be implemented by being changed as explained below. The present embodiment and modifications explained below can be implemented in combination with each other as long as no technical inconsistencies are involved.

In the fourth embodiment, the second electrode 42 may be provided integrally with the conductor housing 80. The drying device 12 may not include the second electrode 42 if the conductor housing 80 is grounded. The conductor housing 80 may function as the second electrode 42.

In the first embodiment and the second embodiment, an amount of applied liquid may be the same in the upstream region 99C and the downstream region 99D and more liquid may be applied to the upstream region 99C than to the downstream region 99D.

In the third embodiment, the first contact section 51 may be configured such that the first upstream region 51A and the first downstream region 51B similarly contain the material having the electromagnetic heat-generating property. The first contact section 51 may be configured such that the first upstream region 51A contains a larger amount of the material having the electromagnetic heat-generating property than the first downstream region 51B.

In the third embodiment, the second contact section 52 may be configured such that the second upstream region 52A and the second downstream region 52B similarly contain the material having the electromagnetic heat-generating property. The second contact section 52 may be configured such that the second upstream region 52A contains a larger amount of the material having the electromagnetic heat-generating property than the second downstream region 52B.

In the third embodiment, the preheating step may be performed in a state in which the medium for preheating 99 is conveyed between the first contact section 51 and the second contact section 52.

Even when the same high-frequency voltage is supplied from the high-frequency voltage generation section 31, the upstream heating section 40A and the downstream heating section 40B may be capable of adjusting the intensity of the electromagnetic waves respectively output by the upstream heating section 40A and the downstream heating section 40B. The control section 50 may directly control the heating value from the upstream heating section 40A and the heating value from the downstream heating section 40B not via the high-frequency voltage generation section 31.

When the same high-frequency voltage is supplied from the high-frequency voltage generation section 31, the intensities of electromagnetic waves output by the upstream heating section 40A and the downstream heating section 40B may be the same. When the same high-frequency voltage is supplied from the high-frequency voltage generation section 31, the intensities of electromagnetic waves output by the plurality of heating sections 40 may be the same.

The drying device 12 may include a plurality of temperature detection sections 53. The drying device 12 may include the temperature detection section 53 that detects the temperature of the first contact section 51 and the temperature detection section 53 that detects the temperature of the second contact section 52. The control section 50 may perform control based on the temperature of the first contact section 51 and the temperature of the second contact section 52. As explained above, the temperature detection section 53 may detect the temperature of at least one of the first contact section 51 and the second contact section 52. The drying device 12 may not include the temperature detection section 53.

In the preheating step, the heating value of the downstream heating section 40B may be larger than the heating value of the upstream heating section 40A. Accordingly, the temperature can be raised higher in the first downstream region 51B and the second downstream region 52B than in the first upstream region 51A and the second upstream region 52A.

The plurality of heating sections 40 may be respectively disposed such that the intersecting direction Y is longitudinal. In this case, the first electrode 41 may be disposed to extend in the intersecting direction Y. The plurality of heating sections 40 may be respectively disposed to be inclined with respect to the width direction X and the intersecting direction Y.

The plurality of heating sections 40 are integrally configured by sharing the second electrode 42 but may not share the second electrode 42. The plurality of heating sections 40 may be respectively configured as separate bodies. The drying unit 30 may include a plurality of heating sections 40 disposed side by side in one row or a plurality of rows in the width direction X. The drying unit 30 may include a plurality of heating sections 40 disposed side by side in one row or a plurality of rows in the intersecting direction Y.

The heating section 40 may heat the medium 90 from the rear surface 90B side of the medium 90. The heating section 40 may heat the medium 90 from both of the front surface 90A side of the medium 90 and the rear surface 90B side of the medium 90. The heating section 40 may be capable of performing scanning in the width direction X.

The drying unit 30 may not include the second contact section 52 if the drying unit 30 includes at least the first contact section 51. The heating section 40 may be disposed in the downward direction Z2 of the medium 90. In this case, the first contact section 51 is disposed in the downward direction Z2 of the medium 90.

The first electrode 41 is not limited to a flat plate shape and may have, for example, a substantially flat plate shape. The substantially flat plate shape has, for example, an extremely large aspect ratio of a shape curved in a thickness direction, which is a direction in the vertical direction Z, or a rectangular shape and may include a linear shape.

The second electrode 42 is not limited to a flat plate shape and may have, for example, a substantially flat plate shape. The substantially flat plate shape has, for example, an extremely large aspect ratio of a shape curved in a thickness direction, which is a direction in the vertical direction Z, or a rectangular shape and may include a linear shape.

At least one of the first electrode surface 41A and the second electrode surface 42A is not limited to a planar shape and may have a substantially planar shape. The substantially planar shape has, for example, an extremely large aspect ratio of a shape curved in the thickness direction, which is the direction along the vertical direction Z, or a rectangular shape and may include a linear shape.

The heating section 40 may not be provided in the drying device 12 and may be provided in the recording device 11. That is, the recording device 11 may include the heating section 40. In this case, the heating section 40 only has to be provided on the downstream side in the conveyance direction D of the recording section 20. As explained above, the heating section 40 may be applied to the recording device 11 rather than the drying device 12.

A lateral printer may be adopted as the recording device 11. The lateral printer is a printer in which the carriage 25 is movable in both of a main scanning direction and a sub scanning direction.

The medium 90 is not limited to the roll body. The medium 90 may be paper, a film or a sheet made of resin, a composite film of resin and metal, a laminate film, a woven fabric, a nonwoven fabric, a metal foil, a metal film, a ceramic sheet, clothing, or the like.

The liquid can be optionally selected if the liquid can perform recording on the medium 90 by adhering to the medium 90. The liquid may be dye ink such as disperse dye ink or reactive dye ink. For example, the ink includes ink in which particles of a functional material including a solid matter such as pigment or metal particles are dissolved, dispersed, or mixed in a solvent and includes various compositions such as aqueous ink, oil-based ink, gel ink, and hot melt ink.

The expression "at least any one of" used in the present specification means one or more of desired choices. As an example, when the number of choices is two, the expression "at least any one of" used in the present specification means only one choice or both of the two choices. As another example, when the number of choices is three or more, the expression "at least any one of" used in the present specification means only one choice or any combination of two or more any choices.

### Appendices

Technical ideas figured out from the embodiments and the modifications explained above and action effects thereof are explained below. The technical ideas and the action effects thereof can be combined with each other within a range where no technical contradictions are involved.

[1] A drying method by a drying device is a drying method by a drying device including a heating section configured to heat a medium onto which liquid is ejected and a first contact section configured to come into contact with the medium between the heating section and the medium, the heating section including: a first electrode; a second electrode disposed to surround the first electrode in plan view from a first direction facing the medium; a first conductor including a coil and configured to electrically couple a transmission line capable of transmitting a high-frequency voltage and the first electrode; and a second conductor configured to electrically couple the transmission line and the second electrode, the drying method including: a drying step of drying an image region of the medium on which an image is recorded; and a preheating step of heating the first contact section before the drying step.

With this configuration, even when the temperature of the first contact section is low, since the preheating step of heating the first contact section is performed before the drying step, the temperature of the first contact section can be raised in advance. Accordingly, it is possible to reduce the difference between the temperature of the first contact section and the temperature of the medium. For this reason, in the drying step, it is possible to make it difficult to transfer the amount of heat for the medium to the first contact section. Therefore, it is possible to improve the drying efficiency of the medium.

[2] In the drying method by the drying device, the preheating step may include heating the first contact section with the heating section in a state in which the first contact section is brought into contact with a medium for preheating to which the liquid is applied.

With this configuration, the temperature of the first contact section that comes into contact with the medium for preheating can be raised in advance by heating the liquid applied to the medium for preheating. Accordingly, in the drying step, it is possible to make it difficult to transfer the amount of heat for the medium to the first contact section. Therefore, it is possible to improve the drying efficiency of the medium.

[3] In the drying method by the drying device, the preheating step may include heating the first contact section with the heating section in a state in which the first contact section is brought into contact with a medium for preheating having an electromagnetic heat-generating property.

With this configuration, the temperature of the first contact section that comes into contact with the medium for preheating can be raised in advance by heating the medium for preheating having the electromagnetic heat-generating property. Accordingly, in the drying step, it is possible to make it difficult to transfer the amount of heat for the medium to the first contact section. Therefore, it is possible to improve the drying efficiency of the medium.

[4] In the drying method by the drying device, the liquid may be pigment ink containing pigment, water, and a solvent, and the preheating step may include heating the first contact section with the heating section such that a first downstream region located downstream in a conveyance direction in which the medium is conveyed has a higher temperature than a first upstream region located upstream in the conveyance direction.

With this configuration, the liquid is the pigment ink containing the pigment, the water, and the solvent. The first contact section is heated by the heating section such that the first downstream region located downstream in the conveyance direction in which the medium is conveyed has a higher temperature than the first upstream region located upstream in the conveyance direction. For this reason, the water contained in the pigment ink can be vaporized by heating the water in the first upstream region and the solvent contained in the pigment ink can be vaporized by heating the solvent in the first downstream region having a higher temperature than the first upstream region. Therefore, it is possible to improve the drying efficiency of the medium.

[5] In the drying method by the drying device, the first contact section may contain a material having an electromagnetic heat-generating property.

With this configuration, since the first contact section containing the material having the electromagnetic heat-generating property is heated, the temperature of the first contact section can be raised in advance. Accordingly, in the drying step, it is possible to make it difficult to transfer the amount of heat for the medium to the first contact section. Therefore, it is possible to improve the drying efficiency of the medium.

[6] In the drying method by the drying device, the liquid may be pigment ink containing pigment, water, and a solvent, and the first contact section may be configured such that a first downstream region located downstream in a conveyance direction in which the medium is conveyed contains a larger amount of the material having the electromagnetic heat-generating property than a first upstream region located upstream in the conveyance direction.

With this configuration, the liquid is the pigment ink containing the pigment, the water, and the solvent. The first contact section contains a larger amount of the material having the electromagnetic heat-generating property in the first downstream region located downstream in the conveyance direction than in the first upstream region located upstream in the conveyance direction. Accordingly, the first contact section is heated by the heating section such that the first downstream region located downstream in the conveyance direction in which the medium is conveyed has a higher temperature than the first upstream region located upstream in the conveyance direction. For this reason, the water contained in the pigment ink can be vaporized by heating the water in the first upstream region and the solvent contained in the pigment ink can be vaporized by heating the solvent in the first downstream region having a higher temperature than the first upstream region. Therefore, it is possible to improve the drying efficiency of the medium.

[7] In the drying method by the drying device, the drying device may include a temperature detection section configured to detect a temperature of the first contact section, and the drying step may include increasing a heating value by the heating section and increasing conveyance speed of the medium when the temperature of the first contact section is equal to or lower than a threshold.

With this configuration, when the temperature of the first contact section is equal to or lower than the threshold, the heating value by the heating section is increased and the conveyance speed of the medium is increased. For this reason, even when the temperature of the first contact section is equal to or lower than the threshold in the drying step, it is possible to improve the drying efficiency of the medium by increasing the heating value by the heating section. In addition, it is possible to reduce damage to the medium by increasing the conveyance speed of the medium.

[8] In the drying method by the drying device, the drying device may include a second contact section configured to sandwich the medium between the second contact section and the first contact section, the liquid may be pigment ink containing pigment, water, and a solvent, and the preheating step may include heating the first contact section and the second contact section before the drying step.

With this configuration, the liquid is the pigment ink containing the pigment, the water, and the solvent. Before the drying step, the second contact section that sandwiches the medium between the second contact section and the first contact section is heated besides the first contact section. For this reason, when the solvent contained in the pigment ink is vaporized, moisture generated when the water contained in the pigment ink is vaporized stays in the vicinity of the medium. Accordingly, it is possible to reduce a difference in a calorific value of the pigment ink due to a type of the medium and a type of the liquid. In addition, since it is possible to improve the airtightness between the first contact section and the second contact section and the medium, it is possible to dry the medium in an environment in which the pigment ink is less likely to oxidize. It is possible to suppress an imbalance in the distance between the medium and the heating section. It is possible to suppress shrinkage of the medium involved in the heating of the medium. For this reason, it is possible to suppress the occurrence of thermal denaturation on the medium. Therefore, it is possible to dry the medium while maintaining the quality of the medium.

In addition, even when the temperature of the second contact section is low, since the preheating step of heating the second contact section is performed before the drying step, the temperature of the second contact section can be raised in advance. Accordingly, it is possible to reduce the difference between the temperature of the second contact section and the temperature of the medium. Therefore, in the drying step, it is possible to make it difficult to transfer the amount of heat for the medium to the second contact section. Therefore, it is possible to improve the drying efficiency of the medium.

[9] A drying device including: a heating section configured to heat a medium onto which liquid is ejected; and a first contact section configured to come into contact with the medium between the heating section and the medium, wherein the heating section includes: a first electrode; a second electrode disposed to surround the first electrode in plan view from a first direction facing the medium; a first conductor including a coil and configured to electrically couple a transmission line capable of transmitting a high-frequency voltage and the first electrode; and a second conductor configured to electrically couple the transmission line and the second electrode, and the first contact section contains a material having an electromagnetic heat-generating property. With this configuration, it is possible to achieve the same effects as the effects in [5].

[10] In the drying device, the liquid may be pigment ink containing pigment, water, and a solvent, and the first contact section may be configured such that a first downstream region located downstream in a conveyance direction in which the medium is conveyed contains a larger amount of the material having the electromagnetic heat-generating property than a first upstream region located upstream in the conveyance direction. With this configuration, it is possible to achieve the same effects as the effects in [6].

[11] The drying device may include: a conveyance section configured to convey the medium; and a temperature detection section configured to detect a temperature of the first contact section, and the heating section may increase a heating value when the temperature of the first contact section is equal to or lower than a threshold, and the conveyance section may increase conveyance speed of the medium when the temperature of the first contact section is equal to or lower than the threshold. With this configuration, it is possible to achieve the same effects as the effects in [7].

[12] The drying device may include a second contact section configured to sandwich the medium between the second contact section and the first contact section, the liquid may be pigment ink containing pigment, water, and a solvent, and the heating section may heat the first contact section and the second contact section. With this configuration, it is possible to achieve the same effects as the effects in [8].

[13] A recording device including: a recording section configured to record an image on a medium by ejecting liquid onto the medium; a heating section configured to heat the medium onto which the liquid is ejected by the recording section; and a first contact section configured to come into contact with the medium between the heating section and the medium, wherein the heating section includes: a first electrode; a second electrode disposed to surround the first electrode in plan view from a first direction facing the medium; a first conductor including a coil and configured to electrically couple a transmission line capable of transmitting a high-frequency voltage and the first electrode; and a second conductor configured to electrically couple the transmission line and the second electrode, wherein the first contact section contains a material having an electromagnetic heat-generating property. With this configuration, it is possible to achieve the same effects as the effects in [5].

What is claimed is:

1. A drying method by a drying device including a heating section configured to heat a medium onto which liquid is ejected and a first contact section configured to come into contact with the medium between the heating section and the medium,
the heating section including:
a first electrode;
a second electrode disposed to surround the first electrode in plan view from a first direction facing the medium;
a first conductor including a coil and configured to electrically couple a transmission line capable of transmitting a high-frequency voltage and the first electrode; and
a second conductor configured to electrically couple the transmission line and the second electrode,
the drying method including:
a drying step of drying an image region of the medium on which an image is recorded; and
a preheating step of heating the first contact section before the drying step.

2. The drying method by the drying device according to claim 1, wherein the preheating step includes heating the first contact section with the heating section in a state in which the first contact section is brought into contact with a medium for preheating to which the liquid is applied.

3. The drying method by the drying device according to claim 1, wherein the preheating step includes heating the first contact section with the heating section in a state in which the first contact section is brought into contact with a medium for preheating having an electromagnetic heat-generating property.

4. The drying method by the drying device according to claim 1, wherein
the liquid is pigment ink containing pigment, water, and a solvent, and
the preheating step includes heating the first contact section with the heating section such that a first downstream region located downstream in a conveyance direction in which the medium is conveyed has a higher temperature than a first upstream region located upstream in the conveyance direction.

5. The drying method by the drying device according to claim 1, wherein the first contact section contains a material having an electromagnetic heat-generating property.

6. The drying method by the drying device according to claim 5, wherein the liquid is pigment ink containing pigment, water, and a solvent, and
the first contact section is configured such that a first downstream region located downstream in a conveyance direction in which the medium is conveyed contains a larger amount of the material having the electromagnetic heat-generating property than a first upstream region located upstream in the conveyance direction.

7. The drying method by the drying device according to claim 1, wherein
the drying device includes a temperature detection section configured to detect a temperature of the first contact section, and
the drying step includes increasing a heating value by the heating section and increasing conveyance speed of the medium when the temperature of the first contact section is equal to or lower than a threshold.

8. The drying method by the drying device according to claim 1, wherein
the drying device includes a second contact section configured to sandwich the medium between the second contact section and the first contact section,
the liquid is pigment ink containing pigment, water, and a solvent, and
the preheating step includes heating the first contact section and the second contact section before the drying step.

9. A drying device comprising:
a heating section configured to heat a medium onto which liquid is ejected; and
a first contact section configured to come into contact with the medium between the heating section and the medium, wherein
the heating section includes:
a first electrode;
a second electrode disposed to surround the first electrode in plan view from a first direction facing the medium;
a first conductor including a coil and configured to electrically couple a transmission line capable of transmitting a high-frequency voltage and the first electrode; and
a second conductor configured to electrically couple the transmission line and the second electrode, and
the first contact section contains a material having an electromagnetic heat-generating property.

10. The drying device according to claim 9, wherein
the liquid is pigment ink containing pigment, water, and a solvent, and
the first contact section is configured such that a first downstream region located downstream in a conveyance direction in which the medium is conveyed contains a larger amount of the material having the electromagnetic heat-generating property than a first upstream region located upstream in the conveyance direction.

11. The drying device according to claim 9, further comprising:
a conveyance section configured to convey the medium; and
a temperature detection section configured to detect a temperature of the first contact section, wherein
the heating section increases a heating value when the temperature of the first contact section is equal to or lower than a threshold, and
the conveyance section increases conveyance speed of the medium when the temperature of the first contact section is equal to or lower than the threshold.

12. The drying device according to claim 9, further comprising a second contact section configured to sandwich the medium between the second contact section and the first contact section, wherein
the liquid is pigment ink containing pigment, water, and a solvent, and
the heating section heats the first contact section and the second contact section.

13. A recording device comprising:
a recording section configured to record an image on a medium by ejecting liquid onto the medium;
a heating section configured to heat the medium onto which the liquid is ejected by the recording section; and
a first contact section configured to come into contact with the medium between the heating section and the medium, wherein
the heating section includes:
a first electrode;
a second electrode disposed to surround the first electrode in plan view from a first direction facing the medium;
a first conductor including a coil and configured to electrically couple a transmission line capable of transmitting a high-frequency voltage and the first electrode; and
a second conductor configured to electrically couple the transmission line and the second electrode, wherein
the first contact section contains a material having an electromagnetic heat-generating property.
